(19) United States
(12) Patent Application Publication
(10) Pub. No.: US 2026/0162566 A1
(43) Pub. Date: Jun. 11, 2026

(54) LIGHTING DISPLAY SUPPORT SYSTEM AND METHODS OF USE THEREOF

(71) Applicant: Balloon Innovations Inc., Westminster, CO (US)

(72) Inventors: Christopher Jon Wicken, JR., Westminster, CO (US); Alex John Fountain, Evergreen, CO (US)

(21) Appl. No.: 19/414,232

(22) Filed: Dec. 9, 2025

Related U.S. Application Data
(60) Provisional application No. 63/729,580, filed on Dec. 9, 2024.

(51) Int. Cl. G09F 7/04; G09F 7/18

(52) U.S. Cl. CPC G09F 7/04; G09F 7/18; G09F 2007/1804; G09F 2007/1839

(57) ABSTRACT

A display support system configured to install and secure cable supported displays, such as marketing signage, art displays, and lighting displays at elevated position.

### TECHNICAL FIELD

The present disclosure is directed to a display support system configured to secure lighting or other cable-supported displays at elevated positions. More specifically, the disclosure described generally herein relates to a display support system that may be used to install and cable-supported support lighting and other displays, such as traditional Christmas lighting strings, art displays, or marketing signage.

### BACKGROUND

Traditional marketing and lighting displays are often placed in elevated positions to both generate a clear line of sight, as well as to make use of generally empty space thus maximizing the display's visual impact. Such traditional displays, such as signage, flags, balloons, lighting, and even artistic presentations are often secured in elevated positions through simple string-based systems. The simplest, and most universal example would be installation of a string of external lights to decorate one's home or other external location. While such configuration is simple, it possesses several practical drawbacks. First, attachment of such traditional lighting systems to an elevated external surface, such as the outside of one's home or work, may be difficult and even dangerous. In a typical scenario a person would have to bring themselves up to the desired elevation, such as by a ladder or other means, which can be dangerous and often impractical. Second, in many cases the elevated surface may not have sufficient positions to secure a traditional lighting display. Such examples may include sheer surfaces with no positions that could be used as a tie-off, hook or other support. Third, in many cases, the weight of the display may make it prohibitively heavy to secure through traditional means.

To overcome such limitations, several attempts have been made to utilize magnetic anchors to secure traditional displays in elevated locations. However, these attempts to position advertising, marketing and even artistic displays in elevated locations have been met with limited success. For example, U.S. Pat. No. 6,422,622 (hereinafter “Bernard”), describes a magnetic installation and removal device having a magnetic anchor secured to a lug which can be further secured to, for example, a string attached to a display, then elevated to a desired location. However, the configuration in Bernard is limited in several significant ways. First, the placement of the magnetic anchor by balancing it on top of a lug and securing it though the placement of a ring over an extended cylindrical element is inefficient and unstable. Such instability is undesirable as a user would be, due to the vertical configuration of the anchor and lug, positioned directly below the unstable anchor. Second, the lug element is not adjustable, making it impossible to magnetically engage an anchor to non-perpendicular, or other angled surfaces. Third, the inability to adjust the lug and anchor portions further makes it very difficult to position the spiral extension to capture a secured anchor that is in a non-perpendicular position. Fourth, spiral extension does not possess a locking mechanism such that during removal of a secured anchor, it may become dislodged and endanger anyone who might be below, not to mention damaging the display itself.

In another example shown in U.S. Pat. No. 10,604,935 (hereinafter “Forgue”), describes a magnetic support clip for supporting decorative lighting and other objects adjacent to gutters, roof eaves, and other structures of homes and other buildings. The support clip of further includes magnet that can secure the clip to a metal gutter. However, the clip of Forgue is limited in that it requires a pre-placed gutters of other metal surface to operate.

As can be seen, there is a need for a single comprehensive solution to the limitations of traditional display support systems, and in particular lighting display supports described above.

### SUMMARY OF THE INVENTION

Aspects of the present invention include a display support system configured to attach and detach a cable mounted display to an external surface via one or more cable coupler assemblies that can preferably be magnetically responsive to a coupler mount secured to an external surface. In one preferred embodiment, a display support system is configured to attach and detach one or more lighting displays having a series of lights positioned along a display cord to an external surface, such as the outside trim or gutter of a user's home or work. Notably, the display support system of the invention may be configured to secure and remove a variety of displays, and preferably displays or components a user's may wish to secure to an external surface, and more preferably displays that include at least one display cable, such as an advertising display, a lighting display as noted above, a rope, display cord, a sign, a banner, a flag, and a balloon display, or a combination of the same.

In one aspect, the present disclosure includes a display support system having a cable coupler assembly configured to secure a cable, wherein the assembly includes in this embodiment: i) an outer shell secured to an inner shell by a hinge, wherein one or both of the outer or inner shell is magnetically responsive; ii) a tension clamp coupled to the cable coupler tensioning the inner and outer shells; and iii) one or more clamping arms secured to the inner shell and configured to secured the cable within the inner shell. In this preferred embodiment, the display support system further includes a coupler mount configured to be secured to an external surface, and wherein the coupler mount is magnetically responsive to the cable coupler.

In one preferred embodiment, the outer shell includes a metal outer shell, while the inner shell includes a plastic inner shell. In one preferred embodiment, the tension clamp is positioned within a channel on the external surface of the outer shell. In another embodiment, the tension clamp includes catches positioned on either end of the clamp which are secured to slots on the outer shell of the cable coupler. In this embodiment, the catches are positioned past the centerline so as to be tensioned in the closed positioned.

In one preferred embodiment, the cable coupler assembly is in the closed position which forms a cable aperture configured to receive the cable. In another embodiment, the one or more clamping arms include cable grooves configured to receive the cable. In this preferred embodiment, the one or more clamping arms include one or more clamping arms secured to the top and bottom of the inner shell and configured such that the clamping arms are interlaced when the cable coupler assembly is in the closed position.

In another embodiment, the disclosure provides for a display support system comprising a cable coupler assembly formed by a: a pair of cable connectors configured to be coupled to one another; an outer shell secured to one or both of the cable connectors; and a cable channel formed by the coupled cable connectors which is configured to secure a cable. In this preferred aspect, the outer shell, or the cable connectors of the cable coupler assembly are magnetically responsive to a coupler mount.

In one preferred embodiment, the coupler mount includes a magnet, which in one embodiment is configured to be secured to an external surface by a fastener or an adhesive. In one preferred embodiment, the cable of the disclosure is selected from: a string, an electric cord, a wire, a metal cable, a plastic cable, twine, and an electric cord having one or more lights. In another embodiment, the cable of the disclosure is secured to a display selected from: a marketing display, a sign, an art exhibit, a lighting display, a sign, a banner, a flag, and a balloon display.

In one preferred embodiment, the display support system includes a mount installer which is configured to be secured to a pole and further configured to secure a coupler mount. In this embodiment, the coupler mount is positioned within a mount insert on the top portion of the mount installer, which can further include a magnet.

In one preferred embodiment, the display support system includes a coupler installer securable to a pole. In a preferred embodiment, the coupler installer and/or said includes a carrier position configured to secure the cable coupler assembly. In this embodiment, the coupler installer is magnetically responsive to the cable coupler assembly, and preferably magnetically responsive to the cable coupler assembly by a magnet positioned adjacent to the carrier position of the coupler installer. In one embodiment, the coupler installer includes one or more arms positioned adjacent to the carrier position.

In one embodiment, coupler installer and/or said fastener installer includes an arm aperture configured to receive a measuring arm. In this preferred embodiment, the arm aperture is responsive to a fastener aperture securing an measuring arm coupler configured to secure the position of the measuring arm in the arm aperture. In one preferred embodiment, the arm measuring arm coupler is a set screw.

In one embodiment, a measuring arm includes a head portion magnetically responsive to the coupler mount or the cable coupler assembly. In this embodiment, the head portion includes a mount plate that is magnetically responsive to the coupler mount. The mount plate includes a metal plate that is magnetically responsive to the magnet positioned within the coupler mount. The head portion can further include a coupler magnet that is magnetically responsive to the cable coupler assembly, and specifically magnetically responsive to a metal portion of the outer shell of the cable coupler assembly.

In one aspect, the disclosure includes a method of using a display support system, the method including: i) attaching a coupler mount to an external surface; ii) securing a cable with a cable coupler assembly which is magnetically responsive to the coupler mount; and iii) contacting the cable coupler assembly to the coupler mount, wherein the assembly is secured to the mount via a magnetic coupling.

In one aspect, the method further includes the step of inserting the coupler mount within a mount installer. In one aspect, the method further includes the step of securing a pole to the mount installer and contacting the coupler mount positioned within the mount installer to an external surface, wherein the step of attaching includes securing the coupler mount to an external surface with a fastener.

In one aspect, the step of securing includes separating the top and bottom portion of the cable coupler assembly into an open position and inserting the cable lengthwise into the opening and closing the cable coupler assembly into a closed position such that the cable is secured within the assembly and extend through a cable aperture. In one aspect, the step of securing further includes contacting the cable with one or more clamping arms position on the internal surface of the assembly. In one aspect, the step of contacting the cable with the one or more clamping arms includes contacting the cable with a plurality of interlaced clamping arms, wherein the plurality of interlaced clamping arms includes a plurality of interlaced clamping arms each having a cable groove configured to receive the cable.

In one aspect, the step of contacting includes contacting the cable coupler assembly to the coupler mount, wherein a magnet secured in the mount forms a magnetic connection with a metal portion of the cable coupler assembly. In one aspect, the metal portion of the cable coupler assembly includes an outer shell that is at least partially metal, which can further be secured over an inner shell. In one aspect, the cable coupler assembly is tensioned in the closed positioned by a tension clamp secured to the outer shell of the assembly, and wherein the inner and outer shell of the assembly are secured by a hinge.

In one aspect, the step of contacting the cable coupler assembly includes securing the cable coupler assembly to a coupler installer, and preferably magnetically securing the cable coupler assembly to a carrier position on the coupler installer. In one aspect, the method further includes the step of securing a pole to the coupler installer and extending the coupler installer so that the cable coupler assembly is magnetically secured with the coupler mount and withdrawing the pole securing the coupler installer.

In one aspect, the method further includes inserting a measuring arm into an arm aperture on the coupler installer, and contacting the head of the measuring arm with a coupler mount secured to an external surface, or a cable coupler assembly secured to a coupler mount secured to an external surface, or contacting the head of the measuring arm includes magnetically contacting the head of the measuring arm with a coupler mount secured to an external surface, or a cable coupler assembly secured to a coupler mount secured to an external surface.

In one aspect, the method further includes the step of extending the measuring arm within the arm aperture to a measured distance (B), and further engaging a measuring arm coupler securing the measuring arm at the measured distance of (B). In this aspect, the method further includes the step of securing a coupler mount to an external surface while the measuring arm is engaged with the first coupler mount at the measured distance of (B).

In one aspect, the disclosure includes a method of using a display support system, the method including: i) attaching a cable with a first cable coupler assembly which is magnetically responsive to the coupler mount; ii) securing a second cable coupler assembly in a coupler installer; iii) inserting a measuring arm into an arm aperture on the coupler installer, wherein the head of the measuring arm is contacting with the first cable coupler assembly; iv) attaching the second cable coupler assembly to the cable, wherein the first and second cable coupler assembly are separated by the measured distance.

In one aspect, the step of securing the second cable coupler includes magnetically securing the second cable coupler assembly to a carrier position on the coupler installer. In one aspect, the step of contacting includes wherein the head of the measuring arm is magnetically coupled with the first cable coupler assembly secured to the cable.

In one aspect, the method further includes coupling the first and second cable coupler assemblies to a coupler mount attached to an external surface. In one aspect, the step of securing includes magnetically coupling the first and second cable coupler assemblies to a coupler mount attached to an external surface

In one aspect, the step of attaching includes separating the top and bottom portion of the cable coupler assembly into an open position and inserting the cable lengthwise into the opening and closing the cable coupler assembly into a closed position such that the cable is secured within the assembly and extend through a cable aperture.

In one aspect, the step of securing further includes contacting the cable with one or more clamping arms position on the internal surface of the assembly. In one aspect, the step of contacting the cable with the one or more clamping arms includes contacting the cable with a plurality of interlaced clamping arms, wherein the plurality of interlaced clamping arms includes a plurality of interlaced clamping arms each having a cable groove configured to receive the cable.

In one aspect, the step of contacting includes contacting the cable coupler assembly to the coupler mount, wherein a magnet secured in the mount forms a magnetic connection with a metal portion of the cable coupler assembly. In one aspect, the metal portion of the cable coupler assembly includes an outer shell that is at least partially metal and secured over an inner shell. In one aspect, the cable coupler assembly is tensioned in the closed positioned by a tension clamp secured to the outer shell of the assembly, and wherein the inner and outer shell of the assembly are secured by a hinge.

Additional aspects of the present invention will become apparent through the detailed explanation below.

### BRIEF DESCRIPTION OF THE FIGURES

FIG. 1A-E: (A) shows a cable coupler assembly in an open positions in one embodiment thereof; (B) shows a cable coupler assembly in closed position with a disarticulated and coupler tension clamp in one embodiment thereof; (C) show various views of a cable coupler assembly in a closed position forming a cable operator in one embodiment thereof; (D) shows a plurality of cable coupler assemblies secured to a cable in one embodiment thereof; and (E) shows a cable coupler assembly being partially positioned in an open position to allow a cable to be inserted into the cable aperture formed in the closed position in one embodiment thereof.

FIG. 2A-E: (A) shows a cable coupler assembly having an outer and inner shell in a closed position as well as a front aperture and a clamping arm configured to receive and secure a cable in one embodiment thereof; (B) shows an isolated tension clamp in one embodiment thereof; (C) shows the top half of an isolated outer shell in one embodiment thereof; (D) shows cable coupler assembly with the top half of an isolated outer shell removed and showing the inner shell in one embodiment thereof; and (E) shows the top half of an isolated outer shell in one embodiment thereof.

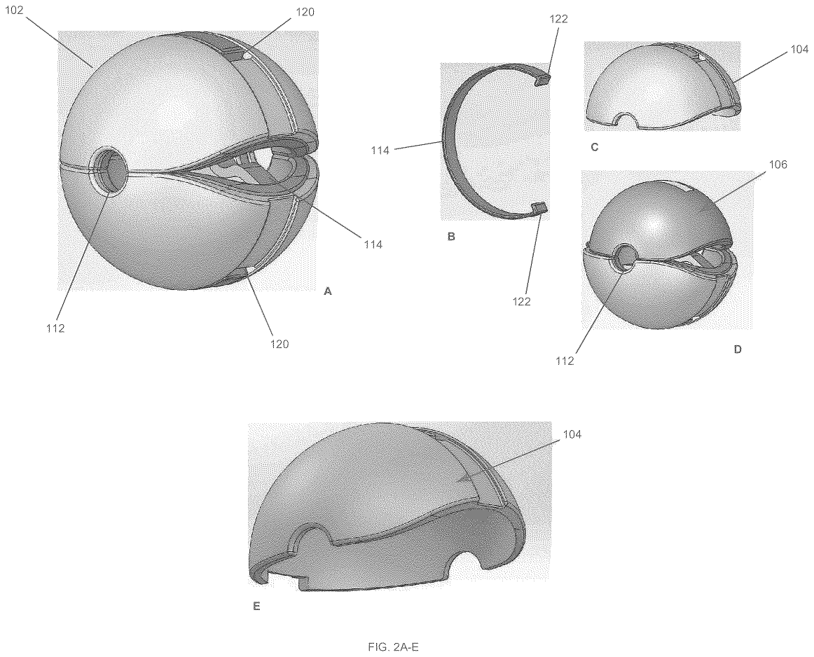

FIG. 3A-B: (A) shows a cable coupler assembly securing a cable magnetically coupled to a couple mount fastened to an external surface in one embodiment thereof; and (B) shows a cable coupler assembly securing a cable positioned adjacent to a couple mount fastened to an external surface in one embodiment thereof.

FIG. 4A-C: (A) shows an isolated measuring are in one embodiment thereof; (B) shows a detailed view of the head of a measuring arm having a mount plate in one embodiment thereof; and (C) shows a detailed view of the head of a measuring arm that has a couple magnet in one embodiment thereof.

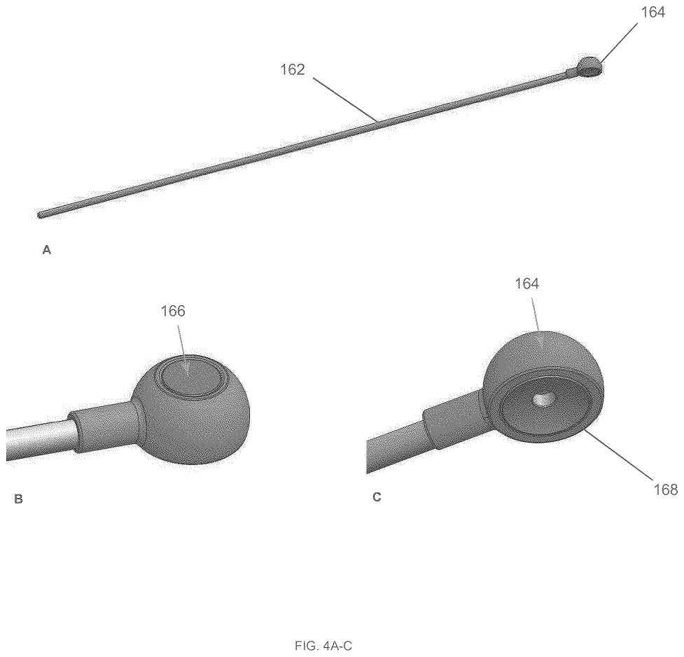

FIG. 5A-D: (A shows a front view of a cable coupler assembly in the closed position in one embodiment thereof; (B) shows a top view of a cable coupler assembly and a centerline transversing the assembly in one embodiment thereof; (C) shows a back view of a cable coupler assembly in the closed position in one embodiment thereof; and (D) shows a side view of a cable coupler assembly in the closed position in one embodiment thereof.

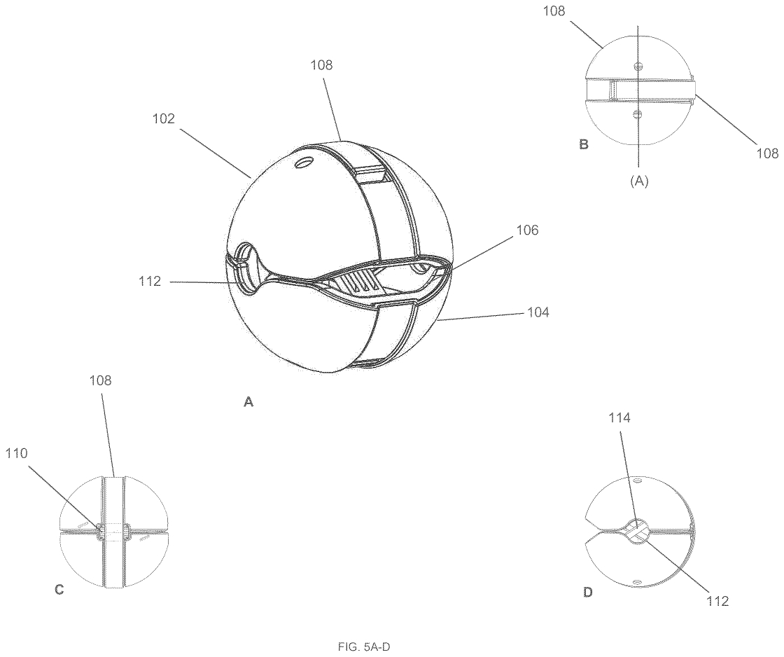

FIG. 6A-D: (A) shows a side view of a coupler installer in one embodiment thereof; (B) shows a side front of a coupler installer in one embodiment thereof; (C) shows a bottom view of a coupler installer in one embodiment thereof; and (D) shows a front perspective view of a coupler installer in one embodiment thereof;

FIG. 7A-B: (A) shows a front view of a mount installer in one embodiment thereof; and (B) shows a front perspective view of a mount installer in one embodiment thereof;

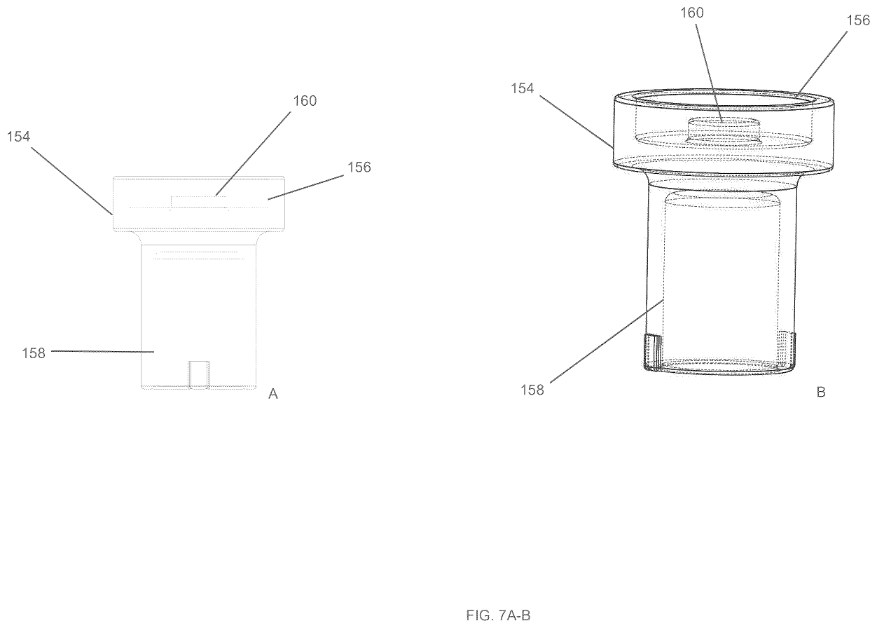

FIG. 8A-D: (A) shows a top view of a coupler mount in one embodiment thereof; (B) shows a side view of a coupler mount in one embodiment thereof; (C) shows a side view of a coupler mount in one embodiment thereof; and (D) shows a front perspective view of a coupler mount in one embodiment thereof.

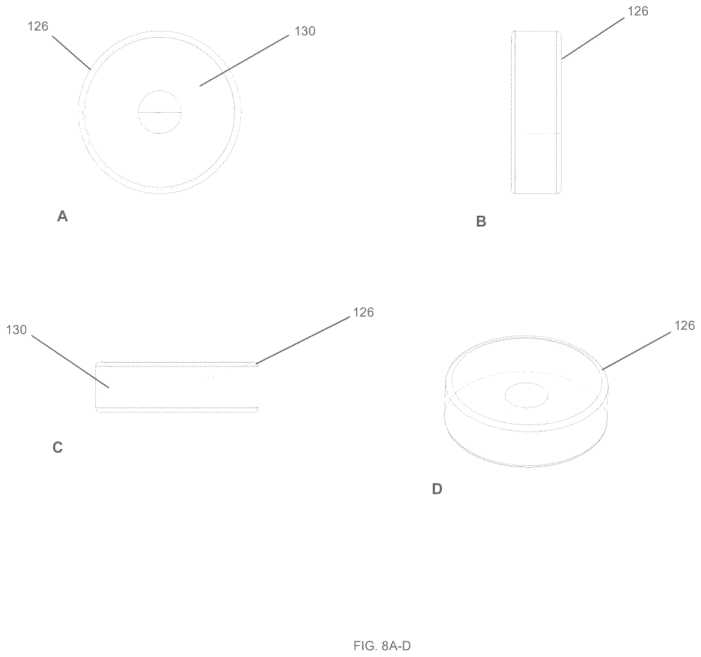

FIG. 9: shows a display support system having a measuring arm positioned adjacent to a coupler mount further secured to a mount installed secured to a pole in one embodiment thereof;

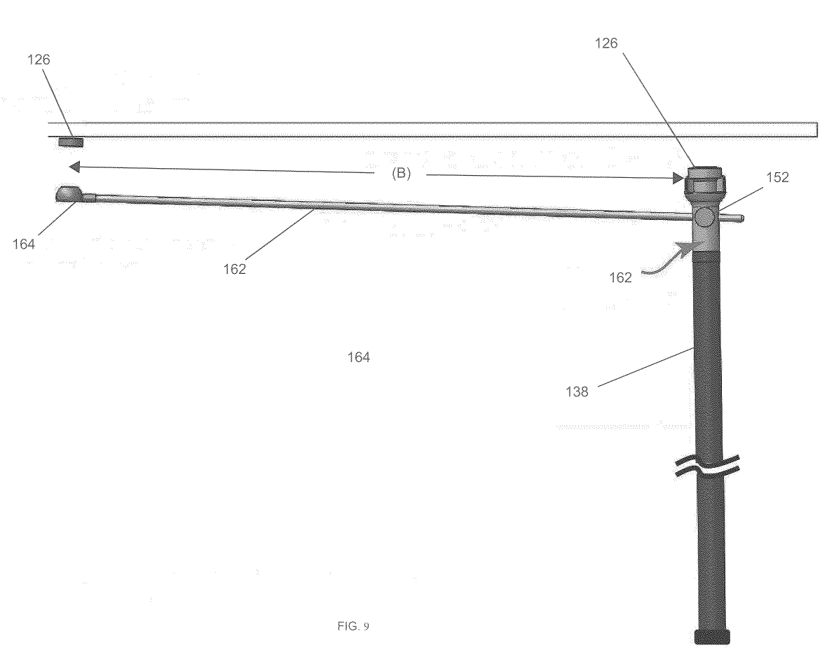

FIG. 10: shows a display support system having a first cable coupler assembly secured to a cable positioned adjacent to a measuring arm which is further coupled with a coupler installed which is further securing a second cable coupler assembly in one embodiment thereof;

FIG. 11A-B: (A) shows a front perspective view of a couple amount in one embodiment thereof; and (B) shows a front perspective view of a couple amount having an adhesive positioned on a top in one embodiment thereof.

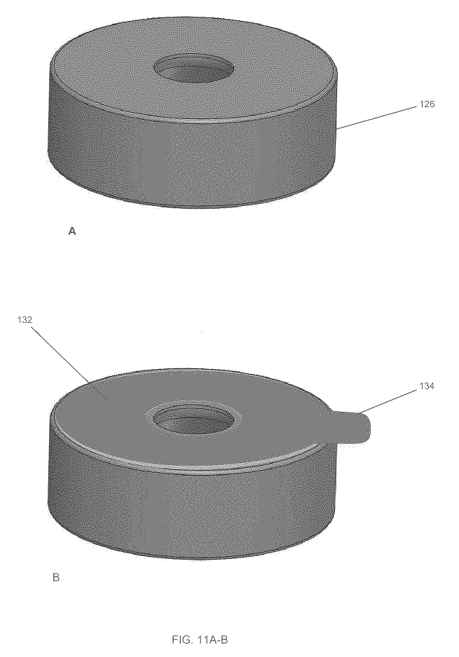

FIG. 12A-B: (A) show an alternative cable coupler assembly as well as an exploded view of a cable connector and outer shell in one embodiment thereof; and (B) show an alternative cable coupler assembly as well as an exploded view of a pair of cable connectors and their corresponding outer shells in one embodiment thereof.

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

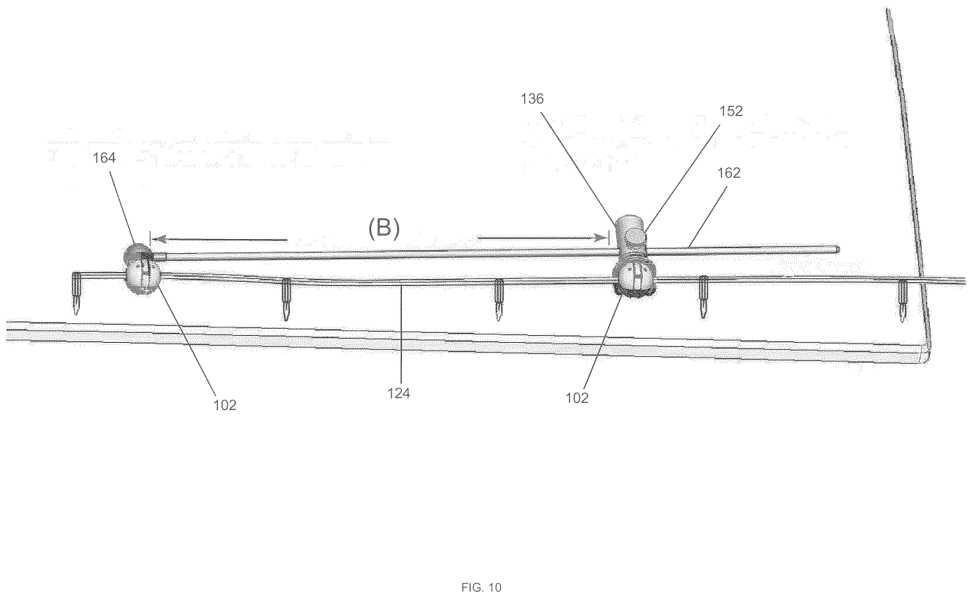

The present disclosure includes systems, methods and apparatus for a display support system (100). In a preferred embodiment, the display support system (100) of the disclosure is configured to attach and detach a cable mounted display to an external surface via one or more cable coupler assemblies that can preferably be magnetically responsive to a coupler mount (126) secured to an external surface. In one preferred embodiment, a display support system (100) is configured to attach and detach one or more lighting displays for example as shown in FIG. 10, having a series of lights positioned along a display cable to an external surface, such as the outside trim or gutter of a user's home or work. As used herein, the term “cable” describes any elongated composition that can be used to hang or secure a display. Examples of a “cable,” can include a string, an electric cord, a wire, a metal cable, a plastic cable, twine, and/or an electric cord having one or more lights.

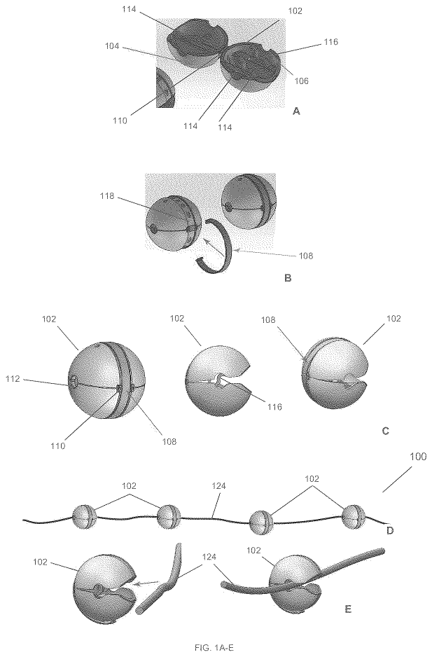

The display support system (100) of the disclosure includes one or more cable coupler assemblies (102) configured to secured one or more cable. Generally referring to the embodiment of FIG. 1, a cable coupler assembly (102) includes outer shell (104) positioned over an inner shell (106) forming an approximately spherical configuration. In a preferred embodiment, the outer shell (104) and or inner shell (106) are magnetically responsive. As used herein, the term “magnetically responsive,” means that the components are capable of forming a magnetic connection with another component. For example, a magnetically responsive component includes a metal component that can be coupled to a magnet.

In a preferred embodiment, all or a portion of the outer shell (104) is formed from a magnetically responsive metal that can form a magnetic connection with a magnet (130) positioned within a coupler mount (126) as described herein. In this embodiment, the inner shell (106) can be formed all or in part from a plastic material. In alternative embodiments, the outer shell (104) can be formed by a plastic or similar material, while the inner shell (104) can be formed all or in part of a metal component that is magnetically responsive to a magnet (130) positioned within a coupler mount (126) as described herein. Referring again to FIG. 1, the cable coupler assembly (102) includes the top and bottom portion of the outer shell (104) secured to corresponding top and bottom portions of the inner shell (106) secured by a hinge (110). In this configuration, the cable coupler assembly (102) can be positioned in an open positions as shown in FIG. 1A, or a closed positions in FIG. 1B.

The cable coupler assembly (102) can be secured in the closed position with a tension clamp (108). As shown in FIG. 1B, the tension clamp (108) can be positioned within a channel (118) that transverses the hinge (110). The terminal ends of the tension clamp (108) can each include a catch (124) configured to be secured with a slot (120) position within the channel (118). In this preferred embodiment, the slots (120) are positioned on the top and bottom halves of the channel (118) of the outer shell (104) such that the catches of the tension clamp (108) are secured with the outer shell (104) beyond the centerline (A) of the assembly (102). In this configuration, the tension clamp (108) generated a compressive force that maintains the cable coupler assembly (102) in the closed position.

The cable coupler assembly (102) can secure a cable (124). In a preferred embodiment, a can be partially transitioned to an open position top allow a cable to be inserted into the internal cavity of the assembly. Generally referring to FIG. 1E, the front portion of the cable coupler assembly (102) can be partially opened allowing a cable to be positioned lengthwise inside the body of the assembly. In this preferred embodiment, a length of cable can be positioned inside the body of the assembly (102) such that it is positioned within the cable aperture (112) with the end existing the sides of the cable coupler assembly (102). In this configuration, the portion of cable (124) positioned within the body of the assembly (102) can be positioned within the cable groove (116) of the one or more clamping arms (112). The tension provided by the clamping arm (114) causes the top and bottom portions of the cable coupler assembly (102) to revert back to the closed position further causing, in this preferred embodiment, the clamping arms (114) to be brought together in an interlaced configuration. The lengthwise portion of the cable (124) positioned within the cable groove (116) is secured within the interlaced configuration of the clamping arms (114) in the closed position.

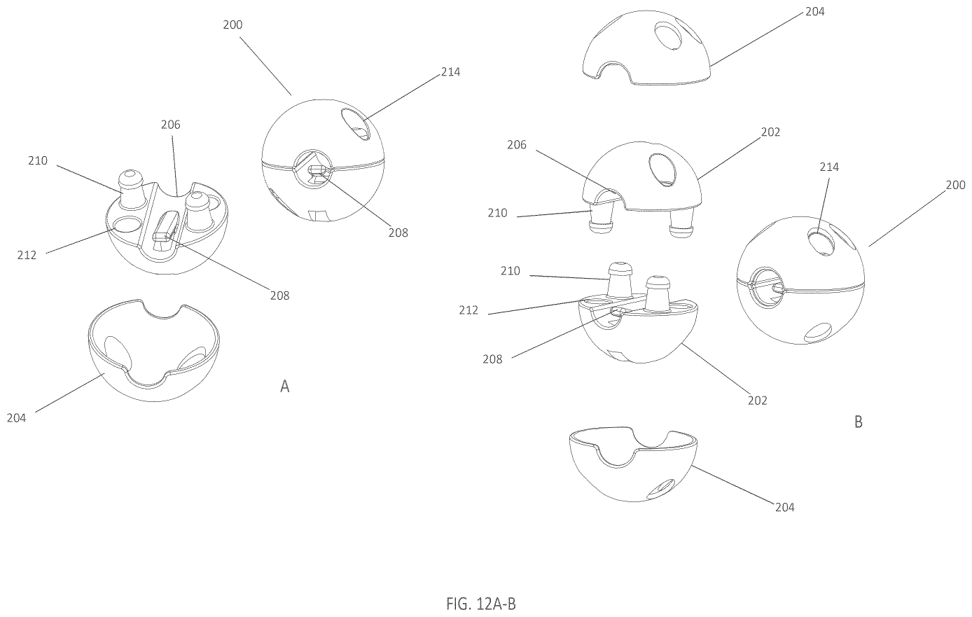

In an alternative embodiment, the disclosure provides for a cable coupler assembly (200). As shown in FIG. 12, in this embodiment the cable coupler assembly (200) can include a pair of cable connectors (202) configured to be coupled to one another. In this embodiment, the cable connectors (202) can include one or more connectors (210) which are configured to be secured in the slot (212) of an opposing cable coupler assembly (200). As shown in FIG. 12, in one embodiment, the connectors (210) of the disclosure can include a beveled extension that can form a secure coupling within the slot (212) of an opposing cable coupler assembly (200). Naturally, additional type of connectors (210) can be employed to secure, as shown in this embodiment cable connectors (202).

Each cable connector (202) includes a cable channel (206) configured such that when a pair of cable connectors (202) are secured together, they form a cable channel (206) capable of securing a cable (124) as generally describe herein. Each cable channel (206) include at least one clamping arm (208), which in the preferred embodiment is shown as an angled protrusion extending into the cable channel (206). In this configuration, when a pair of cable connectors (202) are secured together forming a cable channel (126), the clamping arms (208) are brought into close proximity and compress the cable (124) within the cable channel (206) thereby securing its position.

Referring again to FIG. 12, an outer shell (204) can be secured to the external surface of the cable connectors (202). As noted above, the outer shell (204) can be magnetically responsive to a coupler mount (126). In this embodiment, the outer shell (204) can be formed of a metal that is responsive to a magnet on the coupler mount (126). In alternative embodiment, one or more of the cable connectors (202) can be magnetically responsive to a coupler mount (126). For example, one or more cable connectors (202) can be made of metal, or contain a metal components that is magnetically responsive to a coupler mount (126). The outer shell (204) and cable connectors (202) further form an external aperture (214) positioned over the slot (212) position. In this embodiment, a connector (210) secured within the slot (212) can be disengaged via the application of pressure to the top of the connector (210), for example by a finger or other implement, through the external aperture (214).

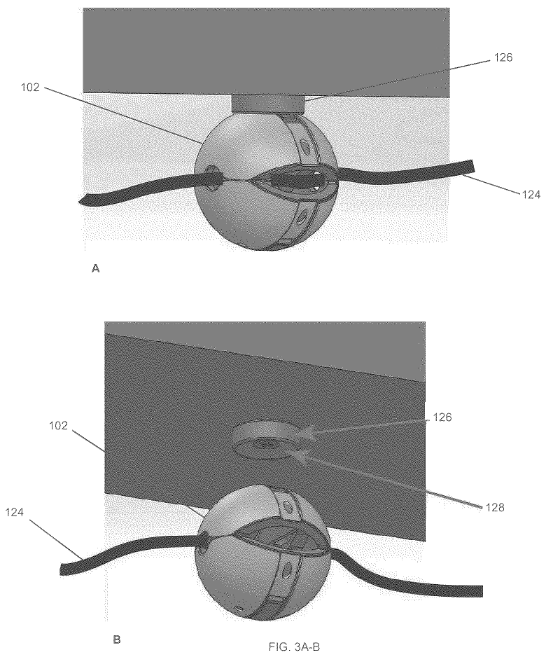

The display support system (100) of the disclosure can include a fastener (128) configured to be secured to an external surface, and preferably an elevated external surface. As shown in FIG. 3, the fastener (128) of the disclosure can be secured to an external surface through a fastener (128), such as a self-tapping screw, or an adhesive (134). As further shown in the figures, the fastener (128) of the disclosure is configured to be magnetically responsive to the cable coupler assembly (102). In a preferred embodiment, the fastener (128) includes a magnet (130) configured to be magnetically responsive to a metal component, and preferably a metal outer shell (104) of the cable coupler assembly (102). In a preferred embodiment, the front surface of the fastener (128) includes a concave surface configured to received and form a flush connection with the outer shell of the cable coupler assembly (102).

The display support system (100) of the disclosure can include a mount installer (154). In the preferred embodiment, the mount installer (154) can include pole coupler (158) position configured to be secured to a mounting pole (138), for example through a threaded coupling. A fastener (128) can be positioned with a mount insert (156) positioned on the top portion of the mount installer (154). The mount insert (156) can further include a magnet configured to be responsive to the magnet (130) of the fastener (128). In this configuration, a fastener (128) can include an adhesive (132), such as VHB™ adhesive, positioned on its bottom surface, optionally with a tab (134) for removal of the adhesive or a covering of the same. The fastener (128) can be positioned in the mount inert (156) with the adhesive (132) facing outward, and optionally secured by the magnet (160). A user can lift the mount installer (154), via a pole, such that the adhesive (132) coated surface of the fastener (128) contacts an external surface at a desired location. In this embodiment, the adhesive (132) adheres to the external surface securing the fastener (128) to the same. Once secured, the user can withdraw the mount installer (154) and repeat the process to secure a plurality of fasteners (128) as desired. Notably, in embodiments where the mount installer (154) includes a magnet (160), the securing force of the adhesive (132) is greater than the magnetic coupling between the fastener (128) and the magnet (160) such that when the mount installer (154) is withdrawn the adhesive (132) and fastener (128) remain adhered to the external surface.

The display support system (100) of the disclosure can include a measuring arm (162) securable to a mount installer (154), for example via an arm aperture (not shown). As shown in FIG. 10, the terminal end of the measuring arm (162) can include a head (164) securing a mount plate (166). In this configuration, the measuring arm (162) can be secured to the mount installer (154) such that the head (164) is positioned at a measured distance (B) from the installer (154). The measuring arm can be secured in place by an arm fastener (152) The mount plate (166) secured to the head (164) of the measuring arm (162) can be magnetically responsive to the magnet (130) of the fastener (128) such that it can form a secure coupling. In this configuration, the measuring arm (162) can be used with the mount installer (154) to ensure a series of fasteners (128) are positioned at a consistent measured distance ensuring uniformity of their positions when placed in series.

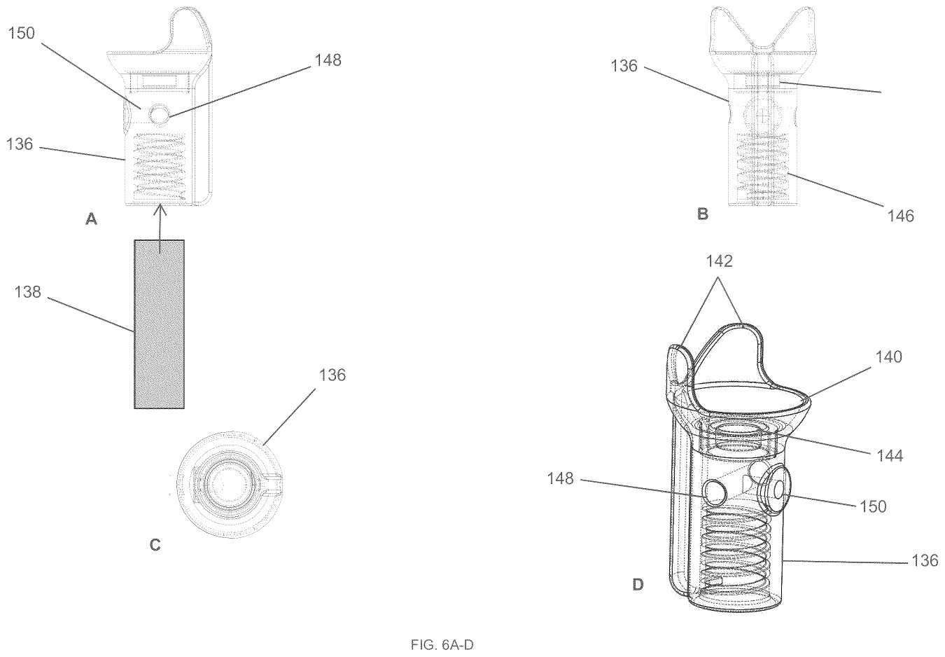

The display support system (100) of the disclosure can include a coupler installer (136). In the preferred embodiment shown in FIG. 6, the coupler installer (136) can include a pole coupler (146) configured to be secured to a pole (138), for example through a threaded coupling. The coupler installer (136) can include a carrier position (140), preferably configured to include a sup-shaped position configured to receive a cable coupler assembly (102), which can further include one or more arms (142) extending upward from the side of the carrier position (140). A cable coupler assembly (102) can further be magnetically responsive to a magnet position at the bottom portion of the carrier position (140). In this configuration, a cable coupler assembly (102) can be magnetically secured within the carrier position (140), and preferably cable coupler assembly (102) that is securing a cable (124) as generally described herein. The secured cable coupler assembly (102) and secured cable (124) can be elevated by the pole (138) and coupler installer (136) so as to be placed adjacent to a fastener (128) secured to an external surface.

In this embodiment, the magnetic force of the magnet (130) of the fastener (128) and the coupler assembly (102) is greater than the magnetic force of between the coupler assembly (102) and the magnet (144) of the coupler installer (136) such that the coupler assembly will adhere more strongly and remain secured to the fastener when the coupler installer (136) is withdrawn. This action can be repeated multiple time to secure a plurality of cable coupler assemblies (102) to a plurality of corresponding fasteners (128) thereby securing a cable (124) to an external surface.

In another embodiment, the coupler installer (136) can be used to detach a cable coupler assembly (102) from a fastener (128). In this embodiment, an empty coupler installer (136) can be elevated to contact the cable coupler assembly (102) forming a magnetic coupling with the magnet (144). The extended arms (142) of the coupler installer (136) can be positioned along the sides of the attached coupler assembly (102) and provide a sheering force that breaks the magnetic coupling between the coupler assembly (102) and magnet (13) of the fastener (128). Once broken, the coupler assembly (102) is secured within the carrier position (140) by the magnetic coupling, in this embodiment, between the metal outer shell (104) of the coupler assembly (102) and the magnet (144) of the coupler installer (136). This action can be repeated multiple times to detach a plurality of cable coupler assemblies (102) from a plurality of corresponding fasteners (128) thereby removing the cable (124) from an external surface. Notably, in this embodiment the fasteners (128) can remain in place such that the coupler assemblies (102), preferably securing a cable can be quickly reattached as desired. In one such an exemplary embodiment, the attachment and detachment of the coupler assemblies (102) from fixed fasteners (128) can be useful for pulling up and removing holiday lights or other seasonal displays and the like.

The coupler installer (136) of the disclosure can further be configured to secure a measuring arm (162). As shown in the embodiment of FIG. 10, a measuring arm (162) can be inserted into an arm aperture (148) on the coupler installer (136), which in this embodiment laterally traverses the coupler installer (136). The terminal end of the measuring arm (162) includes a head (164) securing a coupler magnet (168) configured to be magnetically responsive to the metal portion of the coupler assembly (102). In this configuration, the coupler magnet (168) can be brought into contact with a cable coupler assembly (102) that has been secured to a cable (124), the components forming a magnetic coupling. The measuring arm (162) can be secured to the coupler installer (136), for example by a arm fastener (152) responsive to the measuring arm (162) via an arm aperture (148). In this configuration, the measured distance (b) between a first cable coupler assembly (102) and the installer can be consistent. A second cable coupler assembly (102) can be secured to a cable (124) as described herein at the position of the coupler installer (136). This step can be repeated so as to secure a plurality of cable coupler assemblies (102) to a cable (124) wherein each assembly (102) is positioned at a consistent measured distance (B) from the adjacent coupler assembly (102).

All embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, techniques as well as devices to accomplish an improved display support system and the like. In this application, the methods and apparatus for the aforementioned systems are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention may be described in some instances in method-oriented terminology, each element of the claims corresponds to a device and vice versa. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of a “coupling method and/or technique, and/or device.” Such changes and alternative terms are to be understood to be explicitly included in the description.

Any patents, publications, or other references mentioned in this application for patent, such as in the specification or an IDS are hereby incorporated herein by reference in their entirety. Any priority case(s) claimed by this application are hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods and/or apparatus for providing an improved display support system as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this application also provides support for any combination of elements in the claims and even incorporates any desired proper antecedent basis for certain claim combinations such as with combinations of method, apparatus, process, and the like claims.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

Finally, Applicant reserves the right to seek additional design patent protection over the claimed invention, such that the drawings are fully enabled so as to allow one of ordinary skill in the art to know that the claimed design was in Applicant's possession at the time of filing. As such, it should be noted that any broken lines are to be included for the purpose of illustrating environmental matter and form no part of the claimed design should such become necessary.

1-69. (canceled)

71. A display support system comprising:
a cable coupler assembly comprising:
a pair of cable connectors configured to be coupled to one another;
an outer shell secured to one or both of the cable connectors;
a cable channel formed by the coupled cable connectors;
a coupler mount securable to an external surface, wherein the coupler mount is magnetically responsive to the outer shell, or the cable connectors of the cable coupler assembly; and
a cable positioned in the cable channel.

72. The system in claim 71, wherein the outer shell comprises a metal outer shell, or wherein the cable connectors comprise metal cable connectors.

73. (canceled)

74. The system in claim 71, wherein each of the cable connectors comprises a clamping arm positioned within a cable channel.

75. The system in claim 71, wherein each of the cable connectors comprises one or more connectors configured to be secured in a slot on the opposing cable connector.

76. (canceled)

77. The system in claim 71, wherein said coupler mount comprises a magnet

78. The system in claim 71, wherein said coupler mount is configured to be secured to an external surface by a fastener or an adhesive.

79. The system in claim 71, wherein said cable is selected from: a string, an electric cord, a wire, a metal cable, a plastic cable, twine, and an electric cord having one or more lights

80. The system in claim 71, wherein said cable is secured to a display selected from: a marketing display, a sign, an art exhibit, a lighting display, a sign, a banner, a flag, and a balloon display.

81. The system in claim 71, further comprising a coupler installer securable to a pole and configured to secure the coupler mount.

82. The system in claim 81, wherein the coupler installer is magnetically responsive to the cable coupler assembly.

83. The system in claim 82, wherein the coupler installer is magnetically responsive to the cable coupler assembly by a magnet positioned adjacent to the carrier position.

84. The system in claim 81, wherein the coupler installer comprises one or more arms positioned adjacent to a carrier position.

85. The system in claim 81, wherein the coupler installer comprises an arm aperture configured to receive a measuring arm.

86. The system in claim 85, wherein said arm aperture is responsive to a fastener aperture securing the measuring arm coupler configured to secure the position of the measuring arm in the arm aperture.

87. The system in claim 85, wherein said measuring arm comprises a head portion magnetically responsive to the coupler mount or the cable coupler assembly.

88. The system in claim 87, wherein the head portion comprises a mount plate that is magnetically responsive to the coupler mount.

89. The system in claim 88, wherein said mount plate comprises a metal plate magnetically responsive to the magnet positioned within the coupler mount.

90. The system in claim 88, wherein the head portion comprises a coupler magnet magnetically responsive to the cable coupler assembly.

91. (canceled)

92. A display support system comprising:
a cable coupler assembly comprising:
a cable connector forming a cable channel;
an outer shell secured to one or both of the cable connectors;
a coupler mount securable to an external surface; and
a cable positioned in the cable channel.
